(19) United States
(12) Patent Application Publication
(10) Pub. No.: US 2002/0193478 A1
(43) Pub. Date: Dec. 19, 2002

(54) Polyamide molding compositions for producing transparent films

(76) Inventors: Helmut Schulte, Krefeld (DE); Andreas Gittinger, Krefeld (DE); Cliff Scherer, Schwalmtal (DE); Matthias Mahlke, Koln (DE); Heinrich Morhenn, Koln (DE)

Correspondence Address: BAYER CORPORATION, PATENT DEPARTMENT, 100 BAYER ROAD, PITTSBURGH, PA, 15205, US

(21) Appl. No.: 10/127,370

(22) Filed: Apr. 22, 2002

(30) Foreign Application Priority Data
Apr. 26, 2001 (DE) 10120453.1

(51) Int. Cl. C08K 5/20

(52) U.S. Cl. 524/230

(57) ABSTRACT

A thermoplastic molding composition suitable for making transparent films is disclosed. The composition contains A) a (co)polyamide-6 containing at least 80 wt. % caprolactam units and B) a mixture containing a)an inorganic nucleating agent, b) a glycol ester of a C₄-C₂₀ fatty acid and a polyglycol conforming to (CH₂CH₂O)ₙ, where n>1, and c) an amide derivative of C₄-C₂₀ fatty acid and an amine component selected from the group consisting of C₂-C₁₂ aliphatic monoamine and C₂-C₆ aliphatic diamine.

### FIELD OF THE INVENTION

The present invention provides molding compositions of polyamide/copolyamide and a mixture of inorganic nucleating agents, glycol esters of fatty acids and amide derivatives of higher fatty acids, preparation of the mixture and use of the mixture to produce films.

### SUMMARY OF THE INVENTION

A thermoplastic molding composition suitable for making transparent films is disclosed. The composition contains A) a (co)polyamide-6 containing at least 80 wt. % caprolactam units and B)a mixture containing a)an inorganic nucleating agent, b) a glycol ester of a C₄-C₂₀ fatty acid and a polyglycol conforming to (CH₂CH₂O)ₙ, where n>1, and c) an amide derivative of C₄-C₂₀ fatty acid and an amine component selected from the group consisting of C₂-C₁₂ aliphatic monoamine and C₂-C₆ aliphatic diamine

### BACKGROUND OF THE INVENTION

Films made of polyamide, mostly as multilayered films in association with polyolefins or other plastics, are widely used for packaging foodstuffs and other products.

Polyamide films are generally produced either as flat films by extrusion through a wide slit die or as tubular films by extrusion through a circular die. In the case of multilayered films, either the different layers are extruded in parallel as a composite film or several films are combined with each other in a separate step.

For the production of flat films, polymers of caprolactam are generally used, while in the case of tubular films copolyamides based on caprolactam and other monomers such as e.g. hexamethylenediamine adipate or isophoronediamine isophthalate are used. The comonomers are then incorporated randomly into the polymer.

It is desired that films produced from polyamide have high transparency in addition to high mechanical strength and good oxygen barrier characteristics. When producing films, the freshly extruded film also needs to have good winding characteristics in addition to good extrudability and stability.

EP-A 628 200 discloses that it is possible to produce thin films with thicknesses of 10 to 15 μm at take-off speeds of >50 m/min by the addition of 0.001 to 0.2 wt. % of a suspension which consists of 1 to 50 wt. % (with respect to the entire suspension) of a solid inorganic nucleating agent with a particle size of <25 μm and 50 to 99 wt. % of an organic dispersant from the group of polyalkylene glycols, paraffin oils, carboxylates, organopoly-siloxanes, oxalkylated fatty alcohols, oxalkylated alkylphenols, oxalkylated fatty acids, oxalkylated fatty acid amides and oxalkylated fatty amines.

The polyamides produced according to EP-A 628 200, however, are generally not sufficiently transparent for tubular films and exhibit weaknesses with regard to winding characteristics and further processability in subsequent production units; in particular, polyamides according to EP-A 628 200 are not suitable for the tubular film coextrusion of PA/PE composite films through circular dies because the composite films produced in this way are insufficiently transparent and do not remain very flat or tend to roll up.

Thus, there is the object of producing polyamide films with improved transparency and improved winding characteristics.

In particular, the object was to develop polyamides for film extrusion, preferably tubular film coextrusion, which have improved transparency, remain flat, without any tendency to roll up, and facilitate problem-free further processability of the composite films produced in this way using conventional production and packaging machines.

### DETAILED DESCRIPTION OF THE INVENTION

It has now been found that transparency of the films can be greatly improved by using the mixture according to the invention. As further positive effects, films produced according to the invention have unusually low adhesive and sliding friction values so that, after production, so they can be laid out flat and wound up more easily and also they are easier to handle during further processing in subsequent production units.

The invention provides molding compositions containing

A) (co)polyamide-6 that contains at least 80 wt. % caprolactam units and 50 to 5000 ppm, preferably 500 to 2000 ppm (with respect to the weight of the (co)polyamide of a

B) mixture containing

a) inorganic nucleating agents,

b) glycol esters of fatty acids, derived from a polyglycol conforming to (CH₂CH₂O)ₙ, where n>1 and C₄-C₂₀ fatty acids the fatty acids may be saturated or unsaturated and may preferably be C₁₄ fatty acid , particularly preferably myristic acid, and

c) amide derivatives of higher fatty acids, that include carboxylic acid components which are built up from saturated and unsaturated fatty acids with chain lengths C₄-C₂₀, preferably C₁₈, particularly preferably stearic acid, and amine components which are built up from aliphatic monoamines with carbon chain lengths C₂-C₁₂ or preferably aliphatic diamines with carbon chain lengths C₂-C₆, preferably C₂, particularly preferably ethylenediamine.

Ethylenediamine bis-stearylamide is particularly preferred for c).

The invention also provides molding compositions according to the invention, wherein A) is a copolyamide of polyamide-6 with randomly copolymerized 2-12, preferably 3-8, in particular 6-7 weight percent of equimolar IPD/IPA, or a copolyamide of polyamide-6 with randomly copolymerized 8-20, preferably 12-18, in particular 15 weight percent of polyamide-66.

Mixture B) (with respect to the total weight of molding composition) preferably contains

50-500 ppm, particularly preferably 50-200 ppm of a)

100-1000 ppm, particularly preferably 200-500 ppm of b) and

100-1000 ppm, particularly preferably 300-900 ppm of c).

Mixture B preferably contains

a) talcum

b) ethoxylated myristic acid (e.g. Genagen C 100 from Henkel) and

c) EBS (N,N′-bis-stearoylethylenediamine=[CH₃(CH₂)₁₆(CON—CH₂]₂).

The invention also provides molding compositions according to the invention, wherein mixture B) also contains d) polyalkylene glycol.

Suitable inorganic nucleating agents are those which are already known for nucleating polyamides, such as e.g. barium sulfate, tricalcium phosphate, CaF₂ and, preferably, talcum. The nucleating agents should have a particle size D₉₀ of less than 25 μm, preferably less than 10 μm. (The D₉₀ value denotes the maximum size of 90 percent by weight of the particulate material)

The optionally used polyalkylene glycols, have the general formula

HO—[—CH₂—C(R)H—O—]ₙ—H

in which

R represents H or —CH₃ and

n is an integer from 3 to 100.

A polyethylene glycol with a MW of 300 to 1000 is preferably used.

Mixture B is prepared by conventional methods, e.g. by mixing the components by using a stirrer or a dissolver and then working up the mixture to give a stable dispersion. The mixture is worked up either with a wet mill, e.g. a mechanically agitated mill, a ball mill, a corundum disc mill, a toothed disc mill, an Ultra-Turrax® dispersing machine, a vibratory mill or with a single-roll or multi-roll mill.

Mixture B is preferably mixed with the polyamide granules using conventional mixing equipment, e.g. a double-cone mixer, high-speed mixer, screw mixer, drum mixer or paddle wheel mixer. Alternatively, the components may also preferably be applied to the surface of granules A or incorporated therein separately.

Suitable polyamides for inventive composition are, in addition to polyamide-6, copolyamides which are obtained by polycondensation or polymerisation of at least

| | |
|---|---|
| 80 wt. % | ε-caprolactam and at most |
| 20 wt. % | of one or more other polyamide-forming starting materials. |

Examples of such polyamide-forming starting materials are further lactams such as lauric lactam, ω-aminoacids such as 11-aminoundecanoic acid, and also mixtures of equivalent amounts of one or more dicarboxylic acids such as e.g. adipic acid, sebacic acid, azelaic acid, isophthalic acid or terephthalic acid and one or more diamines such as e.g. hexamethylene diamine, 3-aminomethyl-3,5,5-trimethylcyclohexylamine (isophoronediamine), 4,4′-diaminodicylcohexylmethane, 4,4′-diaminodicylcohexyl-propane-(2,2), m-xylylenediamine, 2,2,4-trimethylhexamethylenediamine or 2,4,4-trimethylhexamethylediamine. The relative viscosity of the polyamides, measured in a 1% strength solution in m-cresol at 25° C., should be at least 3.2, preferably at least 3.4.

The polyamides are prepared in a conventional way by hydrolytic or activated anionic polymerisation of the monomers in batchwise or continuously operated equipment, e.g. autoclaves or precondensation tubes. The residual concentration of monomers and/or oligomers may optionally be removed by vacuum distillation of the polyamide melt or by extraction of the granules obtained from the polyamide melt, e.g. with hot water.

Hydrolytic polymerisation in autoclaves or 1-3-stage PRECONDENSATION tubes with subsequent extraction of the residual monomers in water in the range 95-130° C. and drying in a tower dryer with N₂ or in a drum dryer under vacuum is preferred. The commonly used methods are known to a person skilled in the art and their principles are described in the relevant literature, for example in Ullmann, Encyclopedie der techn. Chemie or Kirk Othmer, Encyclopedia of Chemical Technology.

The relative viscosity can be raised to the desired final value by post condensation of the polyamide granules in the solid state at temperatures of 1 to 100° C., preferably 5 to 50° C., below the melting point of the polyamide.

Preferably conventional single-shaft extruders with single-flighted 3-zone screws or high performance screws which are supplied with shearing and mixing elements are suitable for producing the films. The overall length of the screw should be at least 24 D (D=diameter), better 28 to 33 D. The processing temperature may be, in general, between 200 and 300° C., preferably between 220° C. and 260° C.

For the preferred composite films, the composite film tube extruded through the circular die is blown out with supporting air and is generally cooled from the outside with cooling air. The polyamide layer in this composite film is generally in the external layer; a preferred composite consists of a polyethylene (PE) layer on the internal face of the tube and a polyamide (PA) layer as the external layer. Because the polyethylenes and polyamides used here do not naturally adhere to each other, a thermoplastic bonding agent layer is fed between the PE and the PA layer so that an almost inseparable PA-X-PE composite is produced (X=bonding agent). The products Surlyn® 1652, Bynel® 4288 (both from DuPont) or Plexar® 130 from DSM are preferably used as bonding agents.

The polyamide according to the invention for the PA layer in the coextruded film has a very high transparency and, in combination with the PE layer, the asymmetric PA-X-PE film has no, or only a very slight, tendency to roll up.

The invention also provides use of the molding compositions according to the invention to produce films and use of the molding compositions to produce multilayered tubular coextruded films and a process for preparing polyamide films, wherein mixture B is mixed with the polyamide granules and/or the components for mixture B are applied to the surface of granules A or incorporated therein separately.

The invention provides, in particular, films produced from molding compositions according to the invention.

### EXAMPLES

### Example 1

0.18% of a suspension of 5.5 g talcum in a mixture of 17 g ethoxylated myristic acid, 33.5 g amide wax and 45 g PEG 400 is applied uniformly to granules of a copolyamide consisting of 94 wt. % caprolactam and 6 wt. % isophoronediamine isophthalate. The granules were then extruded together with commercially available polyethylene to give a 2-layered tubular film. The film can be wound up without any problem and exhibits outstanding transparency.

### Example 2

0.1% of a suspension of 9.9 g talcum in a mixture of 29.9 g ethoxylated myristic acid and 60.2 g amide wax is applied uniformly to granules of a copolyamide consisting of 94 wt. % caprolactam and 6 wt. % isophoronediamine isophthalate. The granules were then extruded together with commercially available polyethylene to give a 2-layered tubular film. The film can be wound up without any problem and exhibits outstanding transparency.

### Comparison Example 1

Addition of 0.13 wt. % of a suspension of 10 g talcum and 10 g zinc stearate in 80 g polyethylene glycol with an average molecular weight of 400 to a copolyamide consisting of 94 wt. % caprolactam and 6 wt. % isophoronediamine isophthalate. The granules were then extruded in the same way as in examples 1 and 2 to give a 2-layered tubular film. On winding up, the film tended to form folds. The transparency and gloss were poorer than those in Examples 1 and 2.

| | % Turbidity | Gloss units |
|---|---|---|
| Example 1 | 3.2 | 141.2 |
| Example 2 | 4.1 | 133.0 |
| Comparison example 1 | 14.3 | 77.5 |

The turbidity was measured in accordance with ASTM D 1003 in the polyamide layer.

The film was delaminated for this purpose.

The gloss was measured in accordance with DIN 67530 at the polyamide surface of the composite film.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claiimed is:

1. A molding composition comprising
A) (co)polyamide-6 containing at least 80 wt. % caprolactam units and 50 to 5000 ppm (with respect to the weight of the (co)polyamide of
B) a mixture containing
a) an inorganic nucleating agent,
b) a glycol ester of a C₄-C₂₀ fatty acid and a polyglycol conforming to (CH₂CH₂O)ₙ, where n>1, and
c) an amide derivative of C₄-C₂₀ fatty acid and an amine component selected from the group consisting of C₂-C₁₂ aliphatic monoamine and C₂-C₆ aliphatic diamine.

2. The molding composition according to claim 1, wherein A) is a copolyamide of polyamide-6 and 2-12 weight percent randomly copolymerized equimolar IPD and IPA.

3. The molding composition according to claim 1wherein A) is a copolyamide of polyamide-6 and 8-20 weight percent of a randomly copolymerized polyamide-66.

4. The molding composition according to claim 1 wherein said B) contains:
a) 50-500 ppm
b) 100-1000 ppm and
c) 100-1000 ppm,
with respect to the entire molding composition.

5. The molding composition according to claim 1 wherein B is a suspension containing
a) talcum
b) ethoxylated myristic acid
c) EBS.

6. The molding composition according to claim 5 wherein the suspension also contains d) polyalkylene glycol.

7. A method of using the composition of claim 1 comprising producing a film.

8. A method of using the molding composition of claim 1 comprising producing a multilayered tubular coextruded film.

9. A method of making a film comprising preparing mixture B of claim 1 in suspension B and mixing said suspension with the polyamide in granular form.

10. The film prepared in accordance with claim 7.

11. A film comprising the composition of claim 1.
